(19) United States
(12) Patent Application Publication
(10) Pub. No.: US 2024/0270282 A1
(43) Pub. Date: Aug. 15, 2024

(54) Autonomous Driving Validation System

(71) Applicant: TuSimple, Inc., San Diego, CA (US)

(72) Inventor: Timothy Arthur Jones, Liberty Township, OH (US)

(21) Appl. No.: 18/432,162

(22) Filed: Feb. 5, 2024

Related U.S. Application Data
(60) Provisional application No. 63/484,658, filed on Feb. 13, 2023.

(51) Int. Cl. B60W 60/00; B60W 30/18; B60W 30/182

(52) U.S. Cl. CPC B60W 60/0018; B60W 30/182; B60W 30/18109; B60W 60/0016; B60W 2556/40

(57) ABSTRACT

A sensor failure detection system receives sensor data from sensors associated with an autonomous vehicle. For evaluating a first sensor, the system compares the first sensor data captured by the first sensor to each of map data and other sensor data captured by other sensors. If it is determined that the first sensor fails to detect object(s) that are confirmed to be on the road by the map data and the other sensor data, the system determines that the first sensor fails to detect the object(s) and is not reliable. In response, the system may determine whether the autonomous vehicle can be navigated safely without relying on the first sensor. If it is determined that the autonomous vehicle can be navigated safely without relying on the first sensor, the system may continue autonomous navigation of the autonomous vehicle.

### PRIORITY

This application claims priority to U.S. Provisional Patent Application No. 63/484,658 filed Feb. 13, 2023 and titled “AUTONOMOUS DRIVING VALIDATION SYSTEM,” which is incorporated herein by reference.

### TECHNICAL FIELD

The present disclosure relates generally to autonomous vehicles. More particularly, the present disclosure is related to an autonomous driving validation system.

### BACKGROUND

One aim of autonomous vehicle technology is to provide vehicles that can safely navigate with limited or no driver assistance. The autonomous vehicle relies on its sensors to detect objects. In some situations, a sensor of the autonomous vehicle may fail to detect an object, for example, due to an obstruction between the sensor and the object or a hardware/software failure at the sensor.

### SUMMARY

This disclosure recognizes various problems and previously unmet needs related to autonomous vehicle technology, and more specifically to the lack of the current autonomous vehicle sensor evaluation technology in scenarios where sensor(s) of an autonomous vehicle fail to detect object(s) while the autonomous vehicle is in transit on a road.

In the current technology, once a sensor is calibrated, it is deemed to be reliable and accurate at least until the next calibration of the sensor at a terminal. Therefore, while the autonomous vehicle is traveling on a road, its sensors are deemed to be reliable and accurate, and the sensor data are used for the navigation of the autonomous vehicle. However, in some cases, a sensor may fail due to hardware and/or software failures, power failures, and the like, while the autonomous vehicle is on a road. In some cases, a sensor may fail to detect an object due to being occluded by an object, such as a plastic bag that is covering the sensor, a vehicle that is between the sensor and the object and is blocking the line of sight of the sensor, and the like. The current technology does not provide a solution to evaluate the sensors of an autonomous vehicle while the autonomous vehicle is traveling on the road.

Certain embodiments of the present disclosure provide unique technical solutions to technical problems of current autonomous vehicle navigation technologies, including those problems described above, to improve the autonomous vehicle navigation technologies. More specifically, the present disclosure contemplates unconventional sensor failure detection and sensor performance evaluation methods for evaluating the sensors of an autonomous vehicle. In response to determining that a sensor has failed to detect an object, the disclosed system may take one or more appropriate countermeasures to facilitate the safe operations and navigation of the autonomous vehicle despite the sensor failure as described further below. Accordingly, the disclosed system improves the autonomous vehicle navigation technology and autonomous vehicle sensor evaluation technology.

In an example scenario, assume that the autonomous vehicle is traveling along the road and the sensors capture sensor data that provides information about the road. The control device (i.e., a computer system onboard the autonomous vehicle) receives the sensor data from each sensor and evaluates whether each sensor is performing as expected (i.e., detecting objects on the road). In evaluating the performance of a particular sensor, the control device may determine whether the particular sensor is detecting object(s) on the road. In this process, the control device may compare the sensor data captured by the particular sensor with the map data that includes the locations of objects. The control device may also compare the sensor data captured by the particular sensor with sensor data captured by at least another sensor.

If the control device determines that the map data includes the object at a particular location, and that at least another sensor is detecting the object while the particular sensor does not, the control device may determine that the particular sensor is associated with a first anomaly level—meaning that the sensor may not be reliable and is not performing as expected.

If the inconsistency between the particular sensor and the one or more other sensors, and between the particular sensor and the map data persists for more than a threshold period, the control device may raise the anomaly level/threat level of the particular sensor—increasing the possibility that the particular sensor is faulty, and the object detection failure at the particular sensor is not temporary.

In response, the control device may determine whether the autonomous vehicle is able to safely travel/operate without relying on the particular sensor. For example, if the particular sensor has one or more redundant sensors that have at least some overlapping field of view with the particular sensor, the control device may determine that the autonomous vehicle may be able to rely on the one or more redundant sensors instead of the particular sensor and proceed to travel/operate safely.

The control device may take appropriate actions to facilitate safe traveling/operations for the autonomous vehicle. For example, the control device may instruct the autonomous vehicle to immediately stop, proceed to a particular location and stop, pull over, or operate in a degraded mode (e.g., with reduced speed), among others. In this manner, the disclosed system is configured to determine whether or not a sensor is reliable. If it is determined that a sensor is not reliable, the disclosed system may adjust the operations and navigation course of the autonomous vehicle depending on the position, the field of view, the redundancy factor, and the type of the unreliable sensor to facilitate safe traveling/operations for the autonomous vehicle. Thus, the disclosed system provides a solution for a safer driving experience for the autonomous vehicle, surrounding vehicles, and protecting pedestrians compared to the current autonomous vehicle navigation technology.

In certain embodiments, if multiple sensors fail to detect an object that is indicated in the map data, the control device may determine that the map data is out of date and update the map data 134.

Furthermore, the disclosed system reduces the computational complexity that comes with processing sensor data captured by multiple sensors. For example, if it is determined that a particular sensor is unreliable, the sensor data captured by the particular sensor may be disregarded and not considered in object detection and navigation of the autonomous vehicle. In this way, the unreliable and inaccurate sensor data is not processed which reduces the burden of complex analysis of such sensor data for the control device. Therefore, the disclosed system provides improvements to the underlying operations of the computer systems that are tasked to analyze the sensor data and navigate the autonomous vehicle, for example, by eliminating the processing the unreliable and inaccurate sensor data, the amount of processing and memory resources that would otherwise be used for analyzing such sensor data are reduced. This, in turn, improves the processing and memory resource utilization at the compute systems onboard the autonomous vehicle, and less storage capacity and processing resources may be needed and/or occupied to facilitate the operations of the autonomous vehicle.

In certain embodiments, a system comprises a memory operably coupled to a processor. The memory is configured to store map data that indicates a plurality of objects on a road, wherein the plurality of objects comprises a first object and a second object. The processor is configured to receive first sensor data from a first sensor associated with an autonomous vehicle. The processor compares the first sensor data with the map data. The processor determines that the first sensor data does not indicate a presence of the first object that is indicated in the map data based at least in part upon the comparison between the first sensor data and the map data. In response to determining that the first sensor data does not indicate the presence of the first object that is indicated in the map data, the processor accesses second sensor data captured by a second sensor associated with the autonomous vehicle. The processor determines that the second sensor detects the first object based on determining that the second sensor data indicates the presence of the first object. The processor compares the first sensor data with the second sensor data. The processor determines that the first sensor fails to detect the first object based at least in part upon the comparison between the first sensor data and the second sensor data. The processor determines that the first sensor is associated with a first level of anomaly in response to determining that the first sensor fails to detect the first object.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement a sensor failure detection method;

FIG. 2 illustrates an example flowchart of a method for implementing a sensor failure detection method;

FIG. 3 illustrates a block diagram of an example autonomous vehicle configured to implement autonomous driving operations;

FIG. 4 illustrates an example system for providing autonomous driving operations used by the autonomous vehicle of FIG. 3; and

FIG. 5 illustrates a block diagram of an in-vehicle control computer included in the autonomous vehicle of FIG. 3.

### DETAILED DESCRIPTION

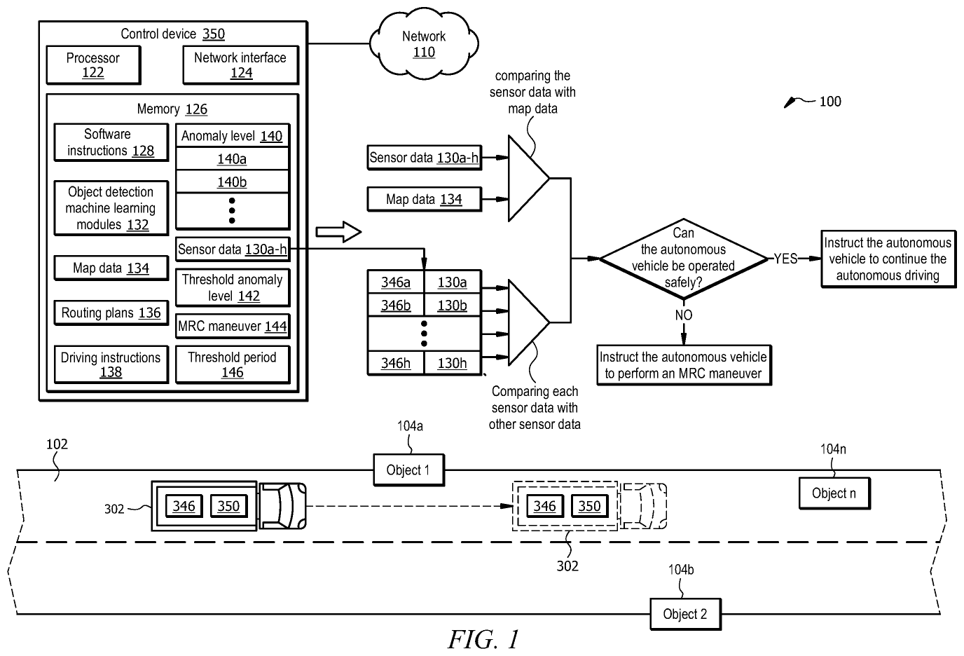

As described above, previous technologies fail to provide efficient, reliable, and safe solutions to evaluate autonomous vehicle sensors while the autonomous vehicle is in transit. The present disclosure provides various systems, methods, and devices to evaluate autonomous vehicle sensors while the autonomous vehicle is in transit and provides navigational solutions to facilitate safer traveling for the autonomous vehicle, surrounding vehicles, and protecting pedestrians if it is determined that one or more sensors are unreliable. Embodiments of the present disclosure and its advantages may be understood by referring to FIGS. 1 through 5. FIGS. 1 through 5 are used to describe a system and method to implement sensor failure detection techniques and navigational solutions to remedy or address sensor failures.

### System Overview

FIG. 1 illustrates an embodiment of a system 100 configured to evaluate autonomous vehicle sensor performance (and failures) and in response to determining that a particular sensor 346 is unreliable, take one or more appropriate countermeasures to facilitate safer traveling for the autonomous vehicle 302. FIG. 1 further illustrates a simplified schematic of a road 102 traveled by the autonomous vehicle 302, where the sensor performance evaluation and sensor failure detection methods are performed. Above the simplified schematic of the road 102, FIG. 1 further illustrates an example operational flow of the system 100 that is performed by the control device 350 to evaluate autonomous vehicle sensor performance (and failures) and in response to determining that a particular sensor 346 is unreliable—meaning that it is failed to detect object(s) and/or failed to perform as expected, take one or more appropriate countermeasures to facilitate safer traveling for the autonomous vehicle 302. The operational flow of the system 100 is described in greater detail further below. In certain embodiments, the system 100 comprises the autonomous vehicle 302. The autonomous vehicle 302 compares a control device 350 that generally facilitates the autonomous operations of the autonomous vehicle 302. The control device 350 comprises a processor 122 in signal communication with a memory 126. Memory 126 stores software instructions 128 that when executed by the processor 122 cause the control device 350 to perform one or more operations described herein. The autonomous vehicle 302 is communicatively coupled to other autonomous vehicles 302, systems, devices, servers, databases, and the like via a network 110. Network 110 allows the autonomous vehicle 302 to communicate with other autonomous vehicles 302, systems, devices, servers, databases, and the like. In other embodiments, system 100 may not have all of the components listed and/or may have other elements instead of, or in addition to, those listed above. System 100 may be configured as shown or in any other configuration.

In general, the system 100 improves the autonomous vehicle navigation technology. In an example scenario, assume that the autonomous vehicle 302 is traveling along the road 102 and the sensors 346 capture sensor data 130 that provides information about the road 102. The control device 350 receives the sensor data 130 from each sensor 346 and evaluates whether each sensor 346 is performing as expected (i.e., detecting objects on the road 102). In evaluating the performance of a particular sensor 346, the control device 360 may determine whether the particular sensor 346 is detecting object(s) 104a-n on the road 102. In this process, the control device 350 may compare the sensor data 130 captured by the particular sensor 346 with the map data 134 that includes the locations of objects 104a-n (the map data 134 is described in greater detail further below). The control device 350 may also compare the sensor data 130 captured by the particular sensor 346 with sensor data 130 captured by at least another sensor 346. If the control device 350 determines that the map data 134 includes the object 104a at the particular location, and that at least another sensor 346 is detecting the object 104a while the particular sensor 346 does not, the control device 350 may determine that the particular sensor 346 is associated with a first level of anomaly 140a.

If the inconsistency between the particular sensor 346 and the one or more other sensors 346, and between the particular sensor 346 and the map data 134 persists for more than a threshold period, the control device 350 may raise the anomaly level/threat level of the particular sensor 346, increasing the possibility that the particular sensor 346 is faulty, and the object detection failure at the particular sensor 346 is not temporary. In response, the control device 350 may determine whether the autonomous vehicle 302 is able to safely travel/operate without relying on the particular sensor 346. For example, if the particular sensor 346 has one or more redundant sensors 346 that have at least some overlapping field of view with the particular sensor 346, the control device 350 may determine that the autonomous vehicle 302 may be able to rely on the one or more redundant sensors instead of the particular sensor and proceed to travel/operate safely.

The control device 350 may take appropriate actions to facilitate safe traveling/operations for the autonomous vehicle 302. For example, the control device 350 may instruct the autonomous vehicle 302 to immediately stop, proceed to a particular location and stop, pull over, or operate in a degraded mode (e.g., with reduced speed), among others.

In this manner, the disclosed system 100 is configured to determine whether or not a sensor 346 is reliable. If it is determined that a sensor 346 is not reliable, the system 100 may adjust the operations and navigation course of the autonomous vehicle 302 depending on the position, the field of view, the redundancy factor, and the type of the unreliable sensor 346 to facilitate the safe traveling/operations for the autonomous vehicle 302. Thus, the disclosed system provides a solution for a safer driving experience for the autonomous vehicle, surrounding vehicles, and protecting pedestrians compared to the current autonomous vehicle navigation technology.

In certain embodiments, if multiple sensors 346 fail to detect an object 104 that is indicated in the map data 134, the control device 350 may determine that the map data 134 is out of date and update the map data 134.

Furthermore, the system 100 reduces the computational complexity that comes with processing sensor data captured by multiple sensors 346. For example, if it is determined that a particular sensor 346 is unreliable, the sensor data captured by the particular sensor 346 may be disregarded and not considered in object detection and navigation of the autonomous vehicle 302. In this way, the unreliable and inaccurate sensor data is not processed which reduces the burden of complex analysis of such sensor data for the control device 350. Therefore, the system 100 provides improvements to the underlying operations of the computer systems that are tasked to analyze the sensor data and navigate the autonomous vehicle 302, for example, by eliminating the processing the unreliable and inaccurate sensor data, the amount of processing and memory resources that would otherwise be used for analyzing such sensor data are reduced. This, in turn, improves the processing and memory resource utilization at the compute systems onboard the autonomous vehicle, and less storage capacity and processing resources may be needed and/or occupied to facilitate the operations of the autonomous vehicle 302.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network.

### Example Autonomous Vehicle

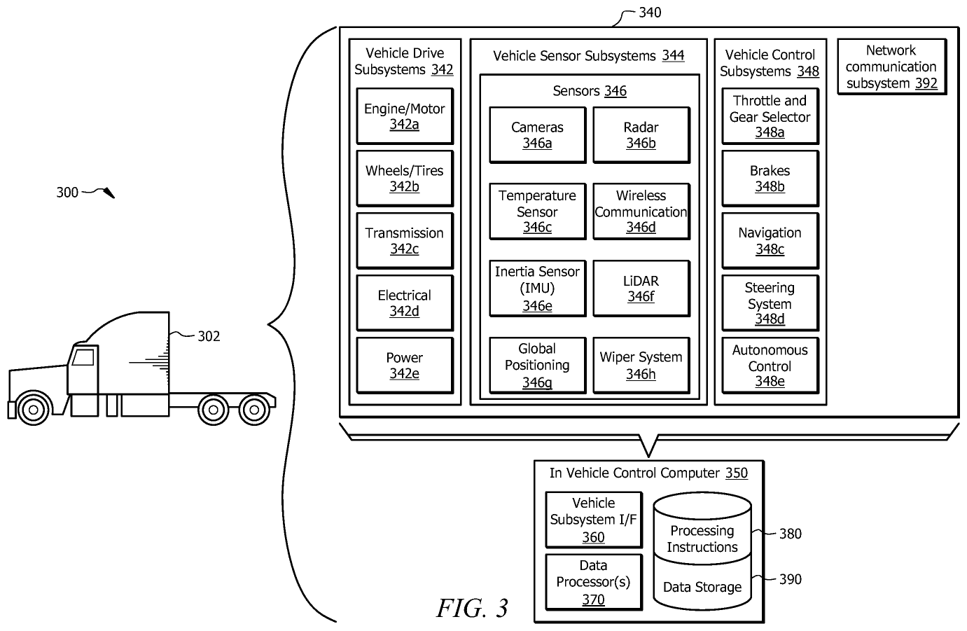

In certain embodiments, the autonomous vehicle 302 may include a semi-truck tractor unit attached to a trailer to transport cargo or freight from one location to another location (see FIG. 3). The autonomous vehicle 302 is generally configured to travel along a road in an autonomous mode. The autonomous vehicle 302 may navigate using a plurality of components described in detail in FIGS. 3-5. The operation of the autonomous vehicle 302 is described in greater detail in FIGS. 3-5. The corresponding description below includes brief descriptions of certain components of the autonomous vehicle 302.

Control device 350 may be generally configured to control the operation of the autonomous vehicle 302 and its components and to facilitate autonomous driving of the autonomous vehicle 302. The control device 350 may be further configured to determine a pathway in front of the autonomous vehicle 302 that is safe to travel and free of objects or obstacles, and navigate the autonomous vehicle 302 to travel in that pathway. This process is described in more detail in FIGS. 3-5. The control device 350 may generally include one or more computing devices in signal communication with other components of the autonomous vehicle 302 (see FIG. 3). In this disclosure, the control device 350 may interchangeably be referred to as an in-vehicle control computer 350.

The control device 350 may be configured to detect objects on and around a road traveled by the autonomous vehicle 302 by analyzing the sensor data 130 and/or map data 134. For example, the control device 350 may detect objects on and around the road by implementing object detection machine learning modules 132. The object detection machine learning modules 132 may be implemented using neural networks and/or machine learning algorithms for detecting objects from images, videos, infrared images, point clouds, audio feed, Radar data, etc. The object detection machine learning modules 132 are described in more detail further below. The control device 350 may receive sensor data 130 from the sensors 346 positioned on the autonomous vehicle 302 to determine a safe pathway to travel. The sensor data 130 may include data captured by the sensors 346.

Sensors 346 may be configured to capture any object within their detection zones or fields of view, such as landmarks, lane markers, lane boundaries, road boundaries, vehicles, pedestrians, road/traffic signs, among others. In some embodiments, the sensors 346 may be configured to detect rain, fog, snow, and/or any other weather condition. The sensors 346 may include a detection and ranging (LiDAR) sensor, a Radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. In some embodiments, the sensors 346 may be positioned around the autonomous vehicle 302 to capture the environment surrounding the autonomous vehicle 302. See the corresponding description of FIG. 3 for further description of the sensors 346.

### Control Device

The control device 350 is described in greater detail in FIG. 3. In brief, the control device 350 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 350 to perform one or more functions described herein.

The processor 122 may be one of the data processors 370 described in FIG. 3. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-5. In some embodiments, the function described herein is implemented using logic units, FPGAs, ASICs, DSPs, or any other suitable hardware or electronic circuitry.

Network interface 124 may be a component of the network communication subsystem 392 described in FIG. 3. The network interface 124 may be configured to enable wired and/or wireless communications. The network interface 124 may be configured to communicate data between the autonomous vehicle 302 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 390 described in FIG. 3. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-5 along with any other data, instructions, logic, rules, or code operable to implement the function(s) described herein when executed by processor 122. For example, the memory 126 may store software instructions 128, sensor data 130, object detection machine learning modules 132, map data 134, routing plan 136, driving instructions 138, anomaly levels 140, threshold anomaly level 142, a minimal risk condition (MRC) maneuver 144, threshold period 146, and/or any other data/instructions. The software instructions 128 include code that when executed by the processor 122 causes the control device 350 to perform the functions described herein, such as some or all of those described in FIGS. 1-5. The memory 126 comprises one or more disks, tape drives, or solid-state drives, and may be used as an over-flow data storage device to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, audio feed, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset that may include samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, audio feed, Radar data, etc. labeled with object(s) in each sample data. The object detection machine learning modules 132 may be trained, tested, and refined by the training dataset and the sensor data 130. The object detection machine learning modules 132 use the sensor data 130 (which are not labeled with objects) to increase their accuracy of predictions in detecting objects. Similar operations and embodiments may apply for training the object detection machine learning modules 132 using the training dataset that includes sound data samples each labeled with a respective sound source and a type of sound. For example, supervised and/or unsupervised machine learning algorithms may be used to validate the predictions of the object detection machine learning modules 132 in detecting objects in the sensor data 130.

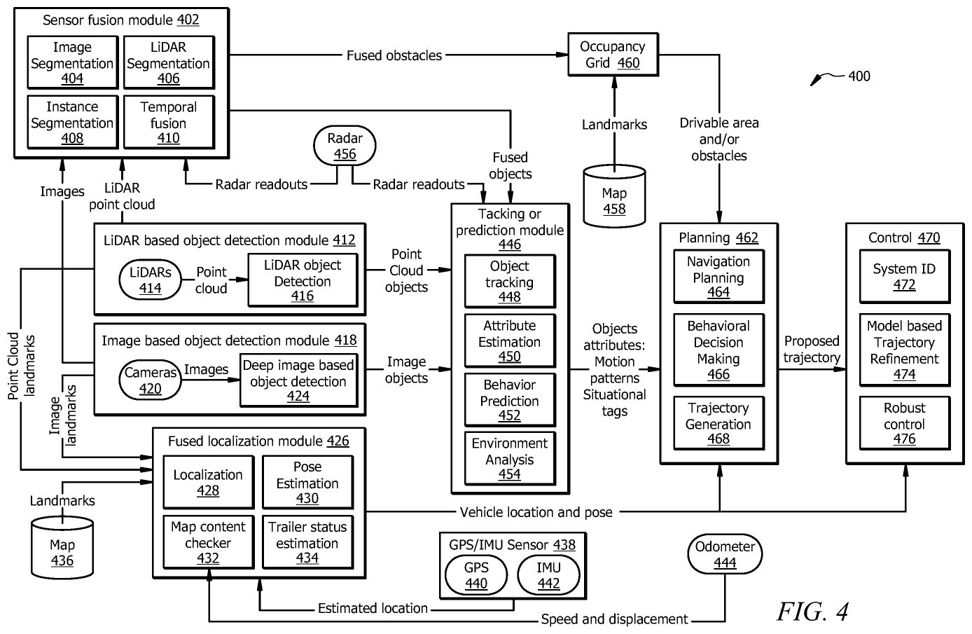

Map data 134 may include a virtual map of a city or an area that includes the road traveled by an autonomous vehicle 302. In some examples, the map data 134 may include the map 458 and map database 436 (see FIG. 4 for descriptions of the map 458 and map database 436). The map data 134 may include drivable areas, such as roads, paths, highways, and undrivable areas, such as terrain (determined by the occupancy grid module 460, see FIG. 4 for descriptions of the occupancy grid module 460). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 462 (See descriptions of the planning module 462 in FIG. 4.). The driving instructions 138 may include instructions and rules to adapt the autonomous driving of the autonomous vehicle 302 according to the driving rules of each stage of the routing plan 136. For example, the driving instructions 138 may include instructions to stay within the speed range of a road traveled by the autonomous vehicle 302, adapt the speed of the autonomous vehicle 302 with respect to observed changes by the sensors 346, such as speeds of surrounding vehicles, objects within the detection zones of the sensors 346, etc.

### Operational Flow for Sensor Failure Detection

In an example scenario, assume that the autonomous vehicle 302 is traveling along the road 102. While traveling, the sensors 346 capture sensor data 130. Each sensor 346 may capture a respective sensor data 130. For example, a first sensor 346a may capture sensor data 130a, a second sensor 346b may capture sensor data 130b, and the sensor 346h may capture sensor data 130h. The sensors 346 may communicate the captured sensor data 130 to the control device 350. The control device 350 may analyze the sensor data 130 to detect objects and determine a safe pathway for the autonomous vehicle 302 to travel autonomously.

In certain embodiments, the route of the autonomous vehicle 302 may be pre-mapped with permanent and/or stationary objects 104a-n and uploaded to the autonomous vehicle 302. Each of the objects 104a-n may be a road sign, a building, a traffic light, road markers, and the like.

While traveling, the control device 350 may evaluate each sensor 346's performance. In this process, the control device 350 may perform the following operations for evaluating the performance of any given sensor 346. In the example below, the evaluation of the first sensor 346 is described.

### Evaluating Sensor Performance in Object Detection

In evaluating the performance of the first sensor 346a, the control device 360 may determine whether the first sensor 346a is detecting a first object 104a that is on the road 102. In this process, the control device 350 may compare the sensor data 130a captured by the first sensor 346a with the map data 134. If the control device 350 determines that the sensor data 130a does not indicate a presence of the object 104a that is included in the map data 134, the control device 350 may determine that the sensor 346a fails to detect the object 104a. In this particular example, assume that based on the comparison between the sensor data 130a and the map data 134, the control device 350 determines that the sensor data 130a does not indicate the presence of the object 104a. In response, the control device 350 may further evaluate the sensor 346a.

In some cases, the sensor 346a's failure to detect the object 104a may be because the sensor 346a is occluded (for example, due to an object that is obstructing at least a portion of the field of view of the sensor 346a preventing the sensor 346a from detecting the object 104a). In some cases, the sensor 346a's failure to detect the object 104a may be because the sensor 346a is faulty (for example, due to hardware/software failure at the sensor 346a).

To further evaluate the first sensor 346a's performance, the control device 350 may compare the sensor data 130a with one or more sensor data 130 captured by one or more other sensors 346 that have at least some overlapping field of view with the first sensor 346a toward the space where the object 104a is located.

In one example, the first sensor 346a and the one or more other sensors 346 may be the same type of sensor (i.e., they all may be camera sensors, Light Detection and Ranging (LiDAR) sensors, Radar sensors, etc.). In the same or another example, the first sensor 346a and the at least another sensor 346 may be different types of sensors (e.g., the first sensor 346a may be a camera, the at least another sensor 346 may be any other type(s) of sensors, such as LiDAR, Radar, etc., or vice versa). In the same or another example, the first sensor 346a and some of the at least another sensor 346 may be the same type of sensor, and the first sensor 346a and the rest of the at least another sensor 346 may be different types—e.g., the first sensor 346a may be one of a first camera, a first LiDAR sensor, a first motion sensor, a first Radar sensor, or a first infrared sensor, and the at least another sensor 346 (including the second sensor 346b) may one of a second camera, a second LiDAR sensor, a second motion sensor, a second Radar sensor, or a second infrared sensor. In this way, the control device 350 may cross-reference different types and combinations of sensors 346 in the sensor performance evaluation and sensor failure detection operations.

The control device 350 may compare the sensor data 130a with the sensor data 130b that is captured by the second sensor 346b. For example, assume that the second sensor 346b detects the object 104a. Therefore, the sensor data 130b indicates the presence of the object 104a. The control device 350 may determine that the second sensor 346b detects the object 104a based on determining that the sensor data 130b indicates the presence of the object 104a. Based on the comparison between the sensor data 130a and sensor data 130b, and the comparison between the sensor data 130a and the map data 134, the control device 350 may determine that the sensor 346a fails to detect the object 104a that is confirmed to be on the road 102 by the map data 134 and the sensor 346b. In other words, the control device 350 may determine that the sensor 346a is inconsistent with the sensor 346b and the map data 134. The control device 350 may also compare the output of the sensor 346a (i.e., sensor data 130a) against other sensors from the same type and/or different type, similar to that described above. In response, the control device 350 may determine that the first sensor 346a is associated with a first level of anomaly 140a—meaning that the sensor 346a may not be reliable and is not performing as expected.

In certain embodiments, determining that the sensor 346a is associated with the first level of anomaly 140a may include determining that the sensor 346a is occluded by an object that is obstructing at least a portion of the field of view of the sensor 346a, such as a plastic bag that is covering the sensor 346a, a vehicle that is between the sensor 346a and the object 104a, and is blocking the line of sight of the sensor 346, and the like.

In certain embodiments, determining that the sensor 346a is associated with the first level of anomaly 140a may include determining that the sensor 346a is faulty, for example, due to hardware and/or software failure at the sensor 346a.

### Determining Whether the Autonomous Vehicle can be Operated Safely Despite the Sensor Failure

In some cases, the autonomous vehicle 302 may be navigated safely without relying on the sensor 346a. In other cases, the autonomous vehicle 302 may not be navigated safely without relying on the sensor 346a. Therefore, the control device 350 may determine whether the autonomous vehicle 302 can be navigated safely without relying on the sensor 346a. In this process, the control device 350 may continue to evaluate the output of the sensor 346a. For example, the control device 350 may continue to compare sensor data 130a against each of the map data 134 and other sensor data 130 captured by other sensors 346.

If the inconsistency between the sensor data 130a and each of the map data 134 and other sensor data 130 persists for more than a threshold period 146 (e.g., more than five minutes, ten minutes, etc.), the control device 350 may indite/penalize the sensor 346a—meaning determining that the sensor 346a is unreliable for navigating the autonomous vehicle 302. The control device 350 may also raise the anomaly level 140 of the sensor 346a to a next level.

During the further evaluation of the sensor 346a, while the autonomous vehicle 302 continues to travel on the road 102, each sensor 346 may capture further sensor data 130 and communicate to the control device 350. For example, the control device 350 may receive second sensor data 130a that is captured by the sensor 346a after the first sensor data 130a described above.

The control device 350 may compare the second sensor data 130a against the map data 134. In the illustrated example, based on the comparison, the control device 350 may determine that the map data 134 indicates that the road 102 includes the object 104b while the sensor data 130a does not indicate a presence of the object 104b.

The control device 350 may also compare the second sensor data 130a against one or more other sensors data 130 captured by one or more other sensors 346 after the first one or more other sensors data 130. In the illustrated example, based on the comparison, the control device 350 may determine that the one or more other sensors 346 detect the object 104b while the sensor 346a does not. In response, the control device 350 may raise the anomaly level 140 of the sensor 346a to a second level of anomaly 140b. If, however, the control device 350 determines that the second sensor data 130a indicates the presence of the object 104b, the control device 350 may determine that the sensor 346a is no longer associated with the first level of anomaly 140a and reduces the anomaly level 140 of the sensor 346a. In other words, if the control device 350 determines that the output of the sensor 346a is consistent with the map data 134 and the output of other sensors 346, the control device 350 may determine that the failure at the sensor 346a was temporary. The control device 350 may continue similar operations for evaluating the sensor 346a.

In certain embodiments, the control device 350 may raise the anomaly level 140 of the sensor 346a to a next level each time the sensor 346a fails to detect an object 104a-n compared to each of other sensor(s) 346 and the map data 134.

In certain embodiments, if the control device 350 determines that the anomaly level 140 of the sensor 346a has become greater than a threshold level 142 (e.g., 5 out of 10, 6 out of 10, etc.), the control device 350 may determine that the sensor 346a is unreliable and whether the autonomous vehicle 302 can be navigated safely without relying on the sensor 346a.

In certain embodiments, if the inconsistency between the sensor data 130a and each of the map data 134 and other sensor data 130 persists for more than a threshold period 146, the control device 350 may determine that the sensor 346a is unreliable and whether the autonomous vehicle 302 can be navigated safely without relying on the sensor 346a.

In certain embodiments, safe navigation of the autonomous vehicle 302 may include keeping a predetermined distance from each object 104a-n, vehicles, and pedestrians, among others, and reaching a predetermined destination without an accident.

In certain embodiments, it may be determined that the autonomous vehicle 302 can be navigated safely without relying on the sensor 346a if the sensor 346a has one or more redundant sensors 346 having at least some overlapping field of view with the sensor 346a. For example, in a camera sensor array, if one camera becomes unreliable and another camera has at least some overlapping field of view as the unreliable camera, it may be determined that the autonomous vehicle 302 can be navigated safely without relying on the unreliable camera. The same may apply to other sensor types, such as LiDAR, Radar, microphone, etc.

In certain embodiments, it may be determined that the autonomous vehicle 302 can be navigated safely without relying on the sensor 346a if the autonomous vehicle 302 is one sensor failure away from being declared as not safe to operate autonomously.

In certain embodiments, if it is determined that the autonomous vehicle 302 can be navigated safely without relying on the sensor 346a, the control device 350 may instruct the autonomous vehicle 302 to continue traveling autonomously without relying on the sensor 346a.

In certain embodiments, if it is determined that the autonomous vehicle 302 cannot be navigated safely without relying on the sensor 346a, the control device 350 may instruct the autonomous vehicle 302 to perform an MRC maneuver 144. The MRC maneuver 144 may include immediately stopping, proceeding to a particular location and stopping, pulling over, or operating in a degraded mode. The degraded mode may include reducing the speed of the autonomous vehicle 302, increasing the traveling distance between the autonomous vehicle 302 and surrounding objects, and/or allowing only maneuvers that do not rely on sensor data 130a captured by the first sensor 346a. For example, if a LiDAR sensor on the left side of the autonomous vehicle 302 is determined to be unreliable, truing left and changing to a left lane may not be allowed. Instead, the autonomous vehicle 302 may be navigated to pull over, or take an exit on the right side, or turn right to get to a suitable spot to pull over. In another example, if a LiDAR sensor on the right side of the autonomous vehicle 302 is determined to be unreliable, the autonomous vehicle 302 may be navigated to stop without hindering traffic.

In certain embodiments, if the control device 350 determines that multiple sensors 346 (e.g., more than a threshold number of sensors 346) fail to detect object(s) 104a-n that is indicated in the map data 134, the control device 350 may determine that the map data 134 is out of date and update the map data 134 by removing the object(s) 104a-n from the map data 134.

In certain embodiments, the control device 350 may communicate the updated map data 134 to one or more other autonomous vehicles 302 and/or a remote oversight server that oversees the operations of the autonomous vehicles 302.

### Example Sensor Failure Detection Method

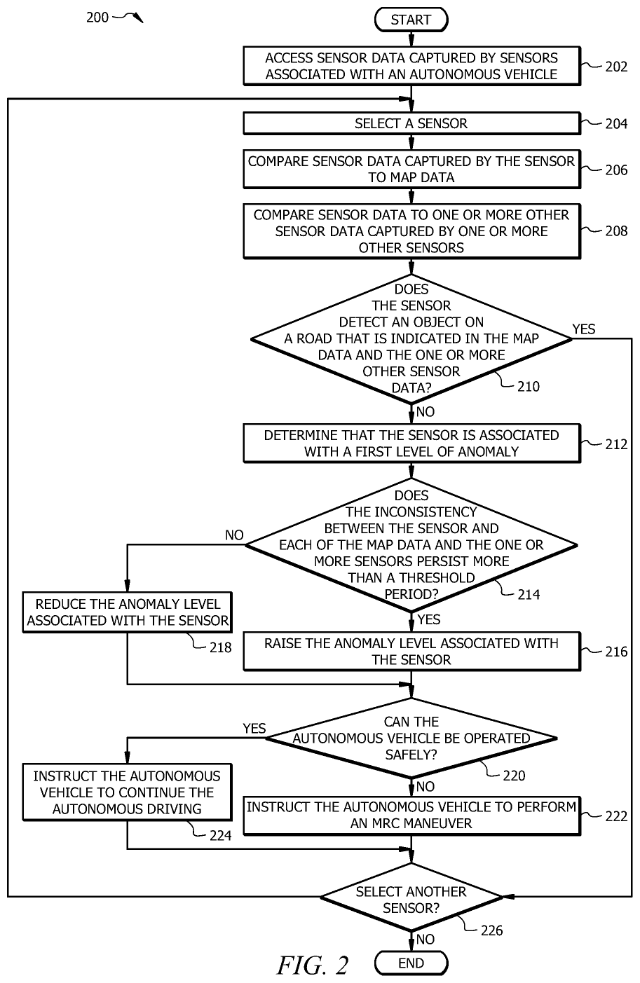

FIG. 2 illustrates an example flowchart of a sensor failure detection method 200. Modifications, additions, or omissions may be made to method 200. Method 200 may include more, fewer, or other operations. For example, operations may be performed in parallel or in any suitable order. While at times discussed as the system 100, autonomous vehicle 302, control device 350, or components of any of thereof performing operations, any suitable system or components of the system may perform one or more operations of the method 200. For example, one or more operations of method 200 may be implemented, at least in part, in the form of software instructions 128 and processing instructions 380, respectively, from FIGS. 1 and 3, stored on non-transitory, tangible, machine-readable media (e.g., memory 126 and data storage 390, respectively, from FIGS. 1 and 3) that when run by one or more processors (e.g., processors 122 and 370, respectively, from FIGS. 1 and 3) may cause the one or more processors to perform operations 202-226.

At operation 202, the control device 350 accesses sensor data 130a-h captured by the sensors 346a-h associated with the autonomous vehicle 302. For example, while the autonomous vehicle 302 is traveling along the road 102, the sensors 346a-h capture sensor data 130a-h and communicate to the control device 350.

At operation 204, the control device 350 selects a sensor 346 from among the sensors 346a-h. The control device 350 may iteratively select a sensor 346 until no sensor 346 is left for evaluation.

At operation 206, the control device 350 compares the sensor data 130 captured by the selected sensor 346 to the map data 134. For example, the control device 350 may feed the sensor data 130 to the object detection machine learning modules 132 to determine if the sensor data 130 indicates any objects.

At operation 208, the control device 350 compares the sensor data 130 captured by the selected sensor 346 to one or more other sensors data 130 captured by one or more other sensors 346.

At operation 210, the control device 350 determines whether the sensor 346 detects an object 104 that is indicated in the map data 134 and the one or more other sensors data 130. For example, the control device 350 may determine whether the output of the sensor 346 is consistent with the output of the other sensors 346 and the map data 134. If it is determined that the sensor 346 detects an object 104 that is indicated in the map data 134 and the one or more other sensors data 130, the method 200 proceeds to operation 226. Otherwise, method 200 proceeds to operation 212.

At operation 212, the control device 350 determines that the sensor 346 is associated with a first level of anomaly 140a. At operation 214, the control device 350 determines whether the inconsistency between the sensor 346 and each of the map data 134 and the one or more other sensors 346 persists more than the threshold period 146. If it is determined that the inconsistency between the sensor 346 and each of the map data 134 and the one or more other sensors 346 persists more than the threshold period 146, method 200 may proceed to operation 216. Otherwise, the method 200 may proceed to operation 218.

At operation 216, the control device 350 raises the anomaly level 140 associated with the sensor 346. For example, with each failure to detect an object, the anomaly level 140 associated with the sensor 346 may be increased to a next level. At operation 218, the control device 350 reduces the anomaly level 140 associated with the sensor 346.

At operation 220, the control device 350 determines whether the autonomous vehicle 302 can be navigated safely. For example, the control device 350 may determine whether the autonomous vehicle 302 can be navigated autonomously and safely without relying on the sensor 346. If it is determined that the autonomous vehicle 302 can be navigated safely, the method 200 may proceed to operation 224. Otherwise, method 200 may proceed to operation 222.

At operation 222, the control device 350 instructs the autonomous vehicle 302 to perform an MRC operation 144. Examples of the MRC operation 144 are described in the discussion of FIG. 1.

At operation 224, the control device 350 instructs the autonomous vehicle 302 to continue the autonomous driving. The control device 350 may also disregard the sensor data 130 captured by the unreliable sensor 346.

At operation 226, the control device 350 determines whether to select another sensor 346. If the control device 350 determines that at least one sensor 346 is left for evaluation, method 200 may return to operation 210. Otherwise, the method 200 may end.

### Example Autonomous Vehicle and its Operation

FIG. 3 shows a block diagram of an example vehicle ecosystem 300 in which autonomous driving operations can be determined. As shown in FIG. 3, the autonomous vehicle 302 may be a semi-trailer truck. The vehicle ecosystem 300 may include several systems and components that can generate and/or deliver one or more sources of information/data and related services to the in-vehicle control computer 350 that may be located in an autonomous vehicle 302. The in-vehicle control computer 350 can be in data communication with a plurality of vehicle subsystems 340, all of which can be resident in the autonomous vehicle 302. A vehicle subsystem interface 360 may be provided to facilitate data communication between the in-vehicle control computer 350 and the plurality of vehicle subsystems 340. In some embodiments, the vehicle subsystem interface 360 can include a controller area network (CAN) controller to communicate with devices in the vehicle subsystems 340.

The autonomous vehicle 302 may include various vehicle subsystems that support the operation of the autonomous vehicle 302. The vehicle subsystems 340 may include a vehicle drive subsystem 342, a vehicle sensor subsystem 344, a vehicle control subsystem 348, and/or network communication subsystem 392. The components or devices of the vehicle drive subsystem 342, the vehicle sensor subsystem 344, and the vehicle control subsystem 348 shown in FIG. 3 are examples. The autonomous vehicle 302 may be configured as shown or any other configurations.

The vehicle drive subsystem 342 may include components operable to provide powered motion for the autonomous vehicle 302. In an example embodiment, the vehicle drive subsystem 342 may include an engine/motor 342a, wheels/tires 342b, a transmission 342c, an electrical subsystem 342d, and a power source 342c.

The vehicle sensor subsystem 344 may include a number of sensors 346 configured to sense information about an environment or condition of the autonomous vehicle 302. The vehicle sensor subsystem 344 may include one or more cameras 346a or image capture devices, a radar unit 346b, one or more thermal sensors 346c, a wireless communication unit 346d (e.g., a cellular communication transceiver), an inertial measurement unit (IMU) 346e, a laser range finder/LiDAR unit 346f, a Global Positioning System (GPS) transceiver 346g, a wiper control system 346h. The vehicle sensor subsystem 344 may also include sensors configured to monitor internal systems of the autonomous vehicle 302 (e.g., an 02 monitor, a fuel gauge, an engine oil temperature, etc.).

The IMU 346e may include any combination of sensors (e.g., accelerometers and gyroscopes) configured to sense position and orientation changes of the autonomous vehicle 302 based on inertial acceleration. The GPS transceiver 346g may be any sensor configured to estimate a geographic location of the autonomous vehicle 302. For this purpose, the GPS transceiver 346g may include a receiver/transmitter operable to provide information regarding the position of the autonomous vehicle 302 with respect to the Earth. The radar unit 346b may represent a system that utilizes radio signals to sense objects within the local environment of the autonomous vehicle 302. In some embodiments, in addition to sensing the objects, the radar unit 346b may additionally be configured to sense the speed and the heading of the objects proximate to the autonomous vehicle 302. The laser range finder or LiDAR unit 346f may be any sensor configured to use lasers to sense objects in the environment in which the autonomous vehicle 302 is located. The cameras 346a may include one or more devices configured to capture a plurality of images of the environment of the autonomous vehicle 302. The cameras 346a may be still image cameras or motion video cameras.

Cameras 346a may be rear-facing and front-facing so that pedestrians, and any hand signals made by them or signs held by pedestrians, may be observed from all around the autonomous vehicle. These cameras 346a may include video cameras, cameras with filters for specific wavelengths, as well as any other cameras suitable to detect hand signals, hand-held traffic signs, or both hand signals and hand-held traffic signs. A sound detection array, such as a microphone or array of microphones, may be included in the vehicle sensor subsystem 344. The microphones of the sound detection array may be configured to receive audio indications of the presence of, or instructions from, authorities, including sirens and commands such as “Pull over.” These microphones are mounted, or located, on the external portion of the vehicle, specifically on the outside of the tractor portion of an autonomous vehicle. Microphones used may be any suitable type, mounted such that they are effective both when the autonomous vehicle is at rest, as well as when it is moving at normal driving speeds.

The vehicle control subsystem 348 may be configured to control the operation of the autonomous vehicle 302 and its components. Accordingly, the vehicle control subsystem 348 may include various elements such as a throttle and gear selector 348a, a brake unit 348b, a navigation unit 348c, a steering system 348d, and/or an autonomous control unit 348e. The throttle and gear selector 348a may be configured to control, for instance, the operating speed of the engine and, in turn, control the speed of the autonomous vehicle 302. The throttle and gear selector 348a may be configured to control the gear selection of the transmission. The brake unit 348b can include any combination of mechanisms configured to decelerate the autonomous vehicle 302. The brake unit 348b can slow the autonomous vehicle 302 in a standard manner, including by using friction to slow the wheels or engine braking. The brake unit 348b may include an anti-lock brake system (ABS) that can prevent the brakes from locking up when the brakes are applied. The navigation unit 348c may be any system configured to determine a driving path or route for the autonomous vehicle 302. The navigation unit 348c may additionally be configured to update the driving path dynamically while the autonomous vehicle 302 is in operation. In some embodiments, the navigation unit 348c may be configured to incorporate data from the GPS transceiver 346g and one or more predetermined maps so as to determine the driving path for the autonomous vehicle 302. The steering system 348d may represent any combination of mechanisms that may be operable to adjust the heading of autonomous vehicle 302 in an autonomous mode or in a driver-controlled mode.

The autonomous control unit 348e may represent a control system configured to identify, evaluate, and avoid or otherwise negotiate potential obstacles or obstructions in the environment of the autonomous vehicle 302. In general, the autonomous control unit 348e may be configured to control the autonomous vehicle 302 for operation without a driver or to provide driver assistance in controlling the autonomous vehicle 302. In some embodiments, the autonomous control unit 348e may be configured to incorporate data from the GPS transceiver 346g, the radar unit 346b, the LiDAR unit 346f, the cameras 346a, and/or other vehicle subsystems to determine the driving path or trajectory for the autonomous vehicle 302.

The network communication subsystem 392 may comprise network interfaces, such as routers, switches, modems, and/or the like. The network communication subsystem 392 may be configured to establish communication between the autonomous vehicle 302 and other systems, servers, etc. The network communication subsystem 392 may be further configured to send and receive data from and to other systems.

Many or all of the functions of the autonomous vehicle 302 can be controlled by the in-vehicle control computer 350. The in-vehicle control computer 350 may include at least one data processor 370 (which can include at least one microprocessor) that executes processing instructions 380 stored in a non-transitory computer-readable medium, such as the data storage device 390 or memory. The in-vehicle control computer 350 may also represent a plurality of computing devices that may serve to control individual components or subsystems of the autonomous vehicle 302 in a distributed fashion. In some embodiments, the data storage device 390 may contain processing instructions 380 (e.g., program logic) executable by the data processor 370 to perform various methods and/or functions of the autonomous vehicle 302, including those described with respect to FIGS. 1-6.

The data storage device 390 may contain additional instructions as well, including instructions to transmit data to, receive data from, interact with, or control one or more of the vehicle drive subsystem 342, the vehicle sensor subsystem 344, and the vehicle control subsystem 348. The in-vehicle control computer 350 can be configured to include a data processor 370 and a data storage device 390. The in-vehicle control computer 350 may control the function of the autonomous vehicle 302 based on inputs received from various vehicle subsystems (e.g., the vehicle drive subsystem 342, the vehicle sensor subsystem 344, and the vehicle control subsystem 348).

FIG. 4 shows an exemplary system 400 for providing precise autonomous driving operations. The system 400 may include several modules that can operate in the in-vehicle control computer 350, as described in FIG. 3. The in-vehicle control computer 350 may include a sensor fusion module 402 shown in the top left corner of FIG. 4, where the sensor fusion module 402 may perform at least four image or signal processing operations. The sensor fusion module 402 can obtain images from cameras located on an autonomous vehicle to perform image segmentation 404 to detect the presence of moving objects (e.g., other vehicles, pedestrians, etc.,) and/or static obstacles (e.g., stop sign, speed bump, terrain, etc.,) located around the autonomous vehicle. The sensor fusion module 402 can obtain LiDAR point cloud data item from LiDAR sensors located on the autonomous vehicle to perform LiDAR segmentation 406 to detect the presence of objects and/or obstacles located around the autonomous vehicle.

The sensor fusion module 402 can perform instance segmentation 408 on image and/or point cloud data items to identify an outline (e.g., boxes) around the objects and/or obstacles located around the autonomous vehicle. The sensor fusion module 402 can perform temporal fusion 410 where objects and/or obstacles from one image and/or one frame of point cloud data item are correlated with or associated with objects and/or obstacles from one or more images or frames subsequently received in time.

The sensor fusion module 402 can fuse the objects and/or obstacles from the images obtained from the camera and/or point cloud data item obtained from the LiDAR sensors. For example, the sensor fusion module 402 may determine based on a location of two cameras that an image from one of the cameras comprising one half of a vehicle located in front of the autonomous vehicle is the same as the vehicle captured by another camera. The sensor fusion module 402 may send the fused object information to the tracking or prediction module 446 and the fused obstacle information to the occupancy grid module 460. The in-vehicle control computer may include the occupancy grid module 460 which can retrieve landmarks from a map database 458 stored in the in-vehicle control computer. The occupancy grid module 460 can determine drivable areas and/or obstacles from the fused obstacles obtained from the sensor fusion module 402 and the landmarks stored in the map database 458. For example, the occupancy grid module 460 can determine that a drivable area may include a speed bump obstacle.

As shown in FIG. 4 below the sensor fusion module 402, the in-vehicle control computer (350 in FIG. 3) may include a LiDAR-based object detection module 412 that can perform object detection 416 based on point cloud data item obtained from the LiDAR sensors 414 located on the autonomous vehicle. The object detection 416 technique can provide a location (e.g., in 3D world coordinates) of objects from the point cloud data item. Below the LiDAR-based object detection module 412, the in-vehicle control computer may include an image-based object detection module 418 that can perform object detection 424 based on images obtained from cameras 420 located on the autonomous vehicle. For example, the object detection 418 technique can employ a deep image-based object detection 424 (e.g., a machine learning technique) to provide a location (e.g., in 3D world coordinates) of objects from the image provided by the camera 420.

The radar 456 on the autonomous vehicle can scan an area surrounding the autonomous vehicle or an area towards which the autonomous vehicle is driven. The Radar data may be sent to the sensor fusion module 402 that can use the Radar data to correlate the objects and/or obstacles detected by the radar 456 with the objects and/or obstacles detected from both the LiDAR point cloud data item and the camera image. The Radar data also may be sent to the tracking or prediction module 446 that can perform data processing on the Radar data to track objects by object tracking module 448 as further described below.

The in-vehicle control computer may include a tracking or prediction module 446 that receives the locations of the objects from the point cloud and the objects from the image, and the fused objects from the sensor fusion module 402. The tracking or prediction module 446 also receives the Radar data with which the tracking or prediction module 446 can track objects by object tracking module 448 from one point cloud data item and one image obtained at one time instance to another (or the next) point cloud data item and another image obtained at another subsequent time instance.

The tracking or prediction module 446 may perform object attribute estimation 450 to estimate one or more attributes of an object detected in an image or point cloud data item. The one or more attributes of the object may include a type of object (e.g., pedestrian, car, or truck, etc.). The tracking or prediction module 446 may perform behavior prediction 452 to estimate or predict the motion pattern of an object detected in an image and/or a point cloud. The behavior prediction 452 can be performed to detect a location of an object in a set of images received at different points in time (e.g., sequential images) or in a set of point cloud data items received at different points in time (e.g., sequential point cloud data items). In some embodiments, the behavior prediction 452 can be performed for each image received from a camera and/or each point cloud data item received from the LiDAR sensor. In some embodiments, the tracking or prediction module 446 can be performed (e.g., run or executed) on received data to reduce computational load by performing behavior prediction 452 on every other or after every pre-determined number of images received from a camera or point cloud data item received from the LiDAR sensor (e.g., after every two images or after every three-point cloud data items).

The behavior prediction 452 feature may determine the speed and direction of the objects that surround the autonomous vehicle from the Radar data, where the speed and direction information can be used to predict or determine motion patterns of objects. A motion pattern may comprise a predicted trajectory information of an object over a pre-determined length of time in the future after an image is received from a camera. Based on the motion pattern predicted, the tracking or prediction module 446 may assign motion pattern situational tags to the objects (e.g., “located at coordinates (x,y),” “stopped,” “driving at 50 mph,” “speeding up” or “slowing down”). The situation tags can describe the motion pattern of the object. The tracking or prediction module 446 may send the one or more object attributes (e.g., types of the objects) and motion pattern situational tags to the planning module 462. The tracking or prediction module 446 may perform an environment analysis 454 using any information acquired by system 400 and any number and combination of its components.

The in-vehicle control computer may include the planning module 462 that receives the object attributes and motion pattern situational tags from the tracking or prediction module 446, the drivable area and/or obstacles, and the vehicle location and pose information from the fused localization module 426 (further described below).

The planning module 462 can perform navigation planning 464 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 464 may include determining an area next to the road where the autonomous vehicle can be safely parked in a case of emergencies. The planning module 462 may include behavioral decision making 466 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 462 performs trajectory generation 468 and selects a trajectory from the set of trajectories determined by the navigation planning operation 464. The selected trajectory information may be sent by the planning module 462 to the control module 470.

The in-vehicle control computer may include a control module 470 that receives the proposed trajectory from the planning module 462 and the autonomous vehicle location and pose from the fused localization module 426. The control module 470 may include a system identifier 472. The control module 470 can perform a model-based trajectory refinement 474 to refine the proposed trajectory. For example, the control module 470 can apply filtering (e.g., Kalman filter) to make the proposed trajectory data smooth and/or to minimize noise. The control module 470 may perform the robust control 476 by determining, based on the refined proposed trajectory information and current location and/or pose of the autonomous vehicle, an amount of brake pressure to apply, a steering angle, a throttle amount to control the speed of the vehicle, and/or a transmission gear. The control module 470 can send the determined brake pressure, steering angle, throttle amount, and/or transmission gear to one or more devices in the autonomous vehicle to control and facilitate precise driving operations of the autonomous vehicle.

The deep image-based object detection 424 performed by the image-based object detection module 418 can also be used detect landmarks (e.g., stop signs, speed bumps, etc.,) on the road. The in-vehicle control computer may include a fused localization module 426 that obtains landmarks detected from images, the landmarks obtained from a map database 436 stored on the in-vehicle control computer, the landmarks detected from the point cloud data item by the LiDAR-based object detection module 412, the speed and displacement from the odometer sensor 444, or a rotary encoder, and the estimated location of the autonomous vehicle from the GPS/IMU sensor 438 (i.e., GPS sensor 440 and IMU sensor 442) located on or in the autonomous vehicle. Based on this information, the fused localization module 426 can perform a localization operation 428 to determine a location of the autonomous vehicle, which can be sent to the planning module 462 and the control module 470.

The fused localization module 426 can estimate pose 430 of the autonomous vehicle based on the GPS and/or IMU sensors 438. The pose of the autonomous vehicle can be sent to the planning module 462 and the control module 470. The fused localization module 426 can also estimate status (e.g., location, possible angle of movement) of the trailer unit based on (e.g., trailer status estimation 434), for example, the information provided by the IMU sensor 442 (e.g., angular rate and/or linear velocity). The fused localization module 426 may also check the map content 432.

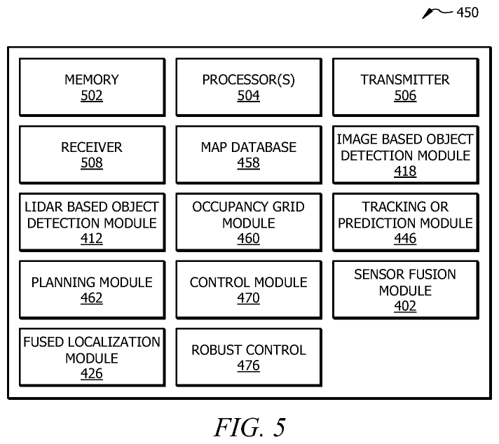

FIG. 5 shows an exemplary block diagram of an in-vehicle control computer 350 included in an autonomous vehicle 302. The in-vehicle control computer 350 may include at least one processor 504 and a memory 502 having instructions stored thereupon (e.g., software instructions 128 and processing instructions 380 in FIGS. 1 and 3, respectively). The instructions, upon execution by the processor 504, configure the in-vehicle control computer 350 and/or the various modules of the in-vehicle control computer 350 to perform the operations described in FIGS. 1-6. The transmitter 506 may transmit or send information or data to one or more devices in the autonomous vehicle. For example, the transmitter 506 can send an instruction to one or more motors of the steering wheel to steer the autonomous vehicle. The receiver 508 receives information or data transmitted or sent by one or more devices. For example, the receiver 508 receives a status of the current speed from the odometer sensor or the current transmission gear from the transmission. The transmitter 506 and receiver 508 also may be configured to communicate with the plurality of vehicle subsystems 340 and the in-vehicle control computer 350 described above in FIGS. 3 and 4.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.
Clause 1. A system comprising:
a memory configured to store map data that indicates a plurality of objects on a road, wherein the plurality of objects comprises a first object and a second object;
a processor, operably coupled to the memory, and configured to:
   receive first sensor data from a first sensor associated with an autonomous vehicle;
   compare the first sensor data with the map data;
   based at least in part upon the comparison between the first sensor data and the map data, determine that the first sensor data does not indicate a presence of the first object that is indicated in the map data;
   in response to determining that the first sensor data does not indicate the presence of the first object that is indicated in the map data:
      access second sensor data captured by a second sensor associated with the autonomous vehicle;
      determine that the second sensor detects the first object based on determining that the second sensor data indicates the presence of the first object;
      compare the first sensor data with the second sensor data;
      based at least in part upon the comparison between the first sensor data and the second sensor data, determine that the first sensor fails to detect the first object; and
      in response to determining that the first sensor fails to detect the first object, determine that the first sensor is associated with a first level of anomaly.
Clause 2. The system of Clause 1, wherein the processor is further configured to:
receive third sensor data from the first sensor, wherein the third sensor data is captured by the first sensor after the first sensor data;
compare the third sensor data with the map data;
based at least in part upon the comparison between the third sensor data and the map data, determine that the third sensor data indicates a presence of the second object that is indicated in the map data; and
in response to determining that the third sensor data indicates the presence of the second object that is indicated in the map data, determine that the first sensor is no longer associated with the first level of anomaly.
Clause 3. The system of Clause 2, wherein the processor is further configured, in response to determining that the third sensor data does not indicate the presence of the second object that is indicated in the map data, to:
access fourth sensor data from the second sensor, wherein the fourth sensor data is captured by the second sensor after the second sensor data;
determine that the second sensor detects the second object based at least in part upon determining that the fourth sensor data indicates the presence of the second object;
compare the fourth sensor data with the third sensor data;
based at least in part upon the comparison between the third sensor data and the fourth sensor data, determine that the first sensor fails to detect the second object; and
in response to determining that the first sensor fails to detect the second object, raise an anomaly level associated with the first sensor to a second level of anomaly.
Clause 4. The system of Clause 3, wherein the processor is further configured to:
determine that the anomaly level associated with the first sensor is greater than a threshold level; and
instruct the autonomous vehicle to perform a minimal risk condition maneuver comprising one of stopping the autonomous vehicle, pulling over the autonomous vehicle, or operating the autonomous vehicle in a degraded mode.
Clause 5. The system of Clause 1, wherein the processor is further configured to:
access a first plurality of sensor data captured by the first sensor, wherein the first plurality of sensor data is captured within a threshold period, wherein the first sensor data is a part of the first plurality of sensor data;
compare each of the first plurality of sensor data with the map data;
access a second plurality of sensor data captured by one or more other sensors associated with the autonomous vehicle, wherein the second sensor data is a part of the second plurality of sensor data;
compare each of the second plurality of sensor data with a counterpart sensor data from among the first plurality of sensor data;
determine that the first sensor fails to detect the plurality of objects within the threshold period based at least in part upon comparing the first plurality of sensor data captured by the first sensor compared to the map data and/or the second plurality of sensor data; and
in response to determining that the first sensor fails to detect the plurality of objects within the threshold period, determine whether the autonomous vehicle is able to travel safely without relying on the first sensor.
Clause 6. The system of Clause 5, wherein the processor is further configured, in response to determining that the autonomous vehicle is able to travel safely without relying on the first sensor, to instruct the autonomous vehicle to continue traveling autonomously.
Clause 7. The system of Clause 5, wherein the processor is further configured, in response to determining that the autonomous vehicle is not able to travel safely without relying on the first sensor, to instruct the autonomous vehicle to perform a minimal risk condition maneuver.
Clause 8. The system of Clause 7, wherein the minimal risk condition maneuver comprises one of the following:
stopping the autonomous vehicle;
pulling over the autonomous vehicle; or
operating the autonomous vehicle in a degraded mode.
Clause 9. The system of Clause 8, wherein the degraded mode comprises at least one of the following:
reducing a speed of the autonomous vehicle;
increasing a traveling distance between the autonomous vehicle and surrounding objects; or
allowing only maneuvers that do not rely on sensor data captured by the first sensor.
Clause 10. A method comprising:
receive first sensor data from a first sensor associated with an autonomous vehicle;
compare the first sensor data with map data, wherein the map data that indicates a plurality of objects on a road, wherein the plurality of objects comprises a first object and a second object;
based at least in part upon the comparison between the first sensor data and the map data, determine that the first sensor data does not indicate a presence of the first object that is indicated in the map data;
in response to determining that the first sensor data does not indicate the presence of the first object that is indicated in the map data:
   access second sensor data captured by a second sensor associated with the autonomous vehicle;
   determine that the second sensor detects the first object based on determining that the second sensor data indicates the presence of the first object;
   compare the first sensor data with the second sensor data;
   based at least in part upon the comparison between the first sensor data and the second sensor data, determine that the first sensor fails to detect the first object; and
   in response to determining that the first sensor fails to detect the first object, determine that the first sensor is associated with a first level of anomaly.
Clause 11. The method of Clause 10, wherein determining that the first sensor is associated with the first level of anomaly comprises determining that the first sensor is occluded by an object obstructing a field of view of the first sensor.
Clause 12. The method of Clause 10, wherein determining that the first sensor is associated with the first level of anomaly comprises determining that the first sensor is faulty.
Clause 13. The method of Clause 10, wherein the first sensor and the second sensor have an overlapping field of view that shows a space where the first object is located.
Clause 14. The method of Clause 10, wherein the first sensor and the second sensor are of a same type of sensor.
Clause 15. The method of Clause 10, wherein the first sensor and the second sensor are different types of sensors.
Clause 16. The method of Clause 10, wherein:
the first sensor is one of a first camera, a first light detection and ranging (LiDAR) sensor, a first motion sensor, a first Radar sensor, or a first infrared sensor; and
the second sensor is one of a second camera, a second LiDAR sensor, a second motion sensor, a second Radar sensor, or a second infrared sensor.
Clause 17. A non-transitory computer-readable medium storing instructions that when executed by a processor, causes the processor to:
receive first sensor data from a first sensor associated with an autonomous vehicle;
compare the first sensor data with map data, wherein the map data that indicates a plurality of objects on a road, wherein the plurality of objects comprises a first object and a second object;
based at least in part upon the comparison between the first sensor data and the map data, determine that the first sensor data does not indicate a presence of the first object that is indicated in the map data;
in response to determining that the first sensor data does not indicate the presence of the first object that is indicated in the map data:
   access second sensor data captured by a second sensor associated with the autonomous vehicle;
   determine that the second sensor detects the first object based on determining that the second sensor data indicates the presence of the first object;
   compare the first sensor data with the second sensor data;
   based at least in part upon the comparison between the first sensor data and the second sensor data, determine that the first sensor fails to detect the first object; and
   in response to determining that the first sensor fails to detect the first object, determine that the first sensor is associated with a first level of anomaly.
Clause 18. The non-transitory computer-readable medium of Clause 17, wherein the instructions when executed by the processor, further cause the processor to:
determine that a plurality of sensors associated with the autonomous vehicle fail to detect the second object that is indicated in the map data;
in response to determining that the plurality of sensors associated with the autonomous vehicle fail to detect the second object that is indicated in the map data:
   determine that the map data is out of data; and
   update the map data by removing the second object from the map data.
Clause 19. The non-transitory computer-readable medium of Clause 17, wherein:
comparing the first sensor data with the map data comprises:
   extracting a first set of features from the first sensor data, the first set of features indicating objects detected by the first sensor data, wherein the first set of features is represented by a first feature vector that comprises a first set of numerical values;
   extracting a second set of features from the map data, the second set of features indicating the plurality of objects, wherein the second set of features is represented by a second feature vector that comprises a second set of numerical values; and
   comparing each of the first set of numerical values of the first feature vector with a counterpart numerical value from among the second set of numerical values,
wherein determining that the first sensor data does not indicate the presence of the first object that is indicated in the map data based at least in part upon the comparison between the first sensor data and the map data comprises:
   determining that the first feature vector does not comprise numerical values that indicate the presence of the first object; and
   determining that the second feature vector comprises the numerical values that indicate the presence of the first object at a particular location on the road.
Clause 20. The non-transitory computer-readable medium of Clause 17, wherein:
comparing the first sensor data with the second sensor data comprises:
   extracting a third set of features from the first sensor data, the third set of features indicating objects detected by the first sensor, wherein the third set of features is represented by a third feature vector that comprises a third set of numerical values;
   extracting a fourth set of features from the second sensor data, the fourth set of features indicating objects detected by the second sensor, wherein the fourth set of features is represented by a fourth feature vector that comprises a fourth set of numerical values; and
   comparing each of the third set of numerical values of the fourth feature vector with a counterpart numerical value from among the fourth set of numerical values,
determining that the first sensor fails to detect the first object that is detected by the second sensor based at least in part upon the comparison between the first sensor data and the second sensor data comprises:
   determining that the third feature vector does not comprise numerical values that indicate the first object is detected on the road; and
   determining that the fourth feature vector comprises the numerical values that indicate the presence of the first object at a particular location on the road.

1. A system comprising:
a memory configured to store map data that indicates a plurality of objects on a road, wherein the plurality of objects comprises a first object and a second object;
a processor, operably coupled to the memory, and configured to:
receive first sensor data from a first sensor associated with an autonomous vehicle;
compare the first sensor data with the map data;
based at least in part upon the comparison between the first sensor data and the map data, determine that the first sensor data does not indicate a presence of the first object that is indicated in the map data;
in response to determining that the first sensor data does not indicate the presence of the first object that is indicated in the map data:
access second sensor data captured by a second sensor associated with the autonomous vehicle;
determine that the second sensor detects the first object based on determining that the second sensor data indicates the presence of the first object;
compare the first sensor data with the second sensor data;
based at least in part upon the comparison between the first sensor data and the second sensor data, determine that the first sensor fails to detect the first object; and
in response to determining that the first sensor fails to detect the first object, determine that the first sensor is associated with a first level of anomaly.

2. The system of claim 1, wherein the processor is further configured to:
receive third sensor data from the first sensor, wherein the third sensor data is captured by the first sensor after the first sensor data;
compare the third sensor data with the map data;
based at least in part upon the comparison between the third sensor data and the map data, determine that the third sensor data indicates a presence of the second object that is indicated in the map data; and
in response to determining that the third sensor data indicates the presence of the second object that is indicated in the map data, determine that the first sensor is no longer associated with the first level of anomaly.

3. The system of claim 2, wherein the processor is further configured, in response to determining that the third sensor data does not indicate the presence of the second object that is indicated in the map data, to:
access fourth sensor data from the second sensor, wherein the fourth sensor data is captured by the second sensor after the second sensor data;
determine that the second sensor detects the second object based at least in part upon determining that the fourth sensor data indicates the presence of the second object;
compare the fourth sensor data with the third sensor data;
based at least in part upon the comparison between the third sensor data and the fourth sensor data, determine that the first sensor fails to detect the second object; and
in response to determining that the first sensor fails to detect the second object, raise an anomaly level associated with the first sensor to a second level of anomaly.

4. The system of claim 3, wherein the processor is further configured to:
determine that the anomaly level associated with the first sensor is greater than a threshold level; and
instruct the autonomous vehicle to perform a minimal risk condition maneuver comprising one of stopping the autonomous vehicle, pulling over the autonomous vehicle, or operating the autonomous vehicle in a degraded mode.

5. The system of claim 1, wherein the processor is further configured to:
access a first plurality of sensor data captured by the first sensor, wherein the first plurality of sensor data is captured within a threshold period, wherein the first sensor data is a part of the first plurality of sensor data;
compare each of the first plurality of sensor data with the map data;
access a second plurality of sensor data captured by one or more other sensors associated with the autonomous vehicle, wherein the second sensor data is a part of the second plurality of sensor data;
compare each of the second plurality of sensor data with a counterpart sensor data from among the first plurality of sensor data;
determine that the first sensor fails to detect the plurality of objects within the threshold period based at least in part upon comparing the first plurality of sensor data captured by the first sensor compared to the map data and/or the second plurality of sensor data; and
in response to determining that the first sensor fails to detect the plurality of objects within the threshold period, determine whether the autonomous vehicle is able to travel safely without relying on the first sensor.

6. The system of claim 5, wherein the processor is further configured, in response to determining that the autonomous vehicle is able to travel safely without relying on the first sensor, to instruct the autonomous vehicle to continue traveling autonomously.

7. The system of claim 5, wherein the processor is further configured, in response to determining that the autonomous vehicle is not able to travel safely without relying on the first sensor, to instruct the autonomous vehicle to perform a minimal risk condition maneuver.

8. The system of claim 7, wherein the minimal risk condition maneuver comprises one of the following:
stopping the autonomous vehicle;
pulling over the autonomous vehicle; or
operating the autonomous vehicle in a degraded mode.

9. The system of claim 8, wherein the degraded mode comprises at least one of the following:
reducing a speed of the autonomous vehicle;
increasing a traveling distance between the autonomous vehicle and surrounding objects; or
allowing only maneuvers that do not rely on sensor data captured by the first sensor.

10. A method comprising:
receive first sensor data from a first sensor associated with an autonomous vehicle;
compare the first sensor data with map data, wherein the map data that indicates a plurality of objects on a road, wherein the plurality of objects comprises a first object and a second object;
based at least in part upon the comparison between the first sensor data and the map data, determine that the first sensor data does not indicate a presence of the first object that is indicated in the map data;
in response to determining that the first sensor data does not indicate the presence of the first object that is indicated in the map data:
access second sensor data captured by a second sensor associated with the autonomous vehicle;
determine that the second sensor detects the first object based on determining that the second sensor data indicates the presence of the first object;
compare the first sensor data with the second sensor data;
based at least in part upon the comparison between the first sensor data and the second sensor data, determine that the first sensor fails to detect the first object; and
in response to determining that the first sensor fails to detect the first object, determine that the first sensor is associated with a first level of anomaly.

11. The method of claim 10, wherein determining that the first sensor is associated with the first level of anomaly comprises determining that the first sensor is occluded by an object obstructing a field of view of the first sensor.

12. The method of claim 10, wherein determining that the first sensor is associated with the first level of anomaly comprises determining that the first sensor is faulty.

13. The method of claim 10, wherein the first sensor and the second sensor have an overlapping field of view that shows a space where the first object is located.

14. The method of claim 10, wherein the first sensor and the second sensor are of a same type of sensor.

15. The method of claim 10, wherein the first sensor and the second sensor are different types of sensors.

16. The method of claim 10, wherein:
the first sensor is one of a first camera, a first light detection and ranging (LiDAR) sensor, a first motion sensor, a first Radar sensor, or a first infrared sensor; and
the second sensor is one of a second camera, a second LiDAR sensor, a second motion sensor, a second Radar sensor, or a second infrared sensor.

17. A non-transitory computer-readable medium storing instructions that when executed by a processor, causes the processor to:
receive first sensor data from a first sensor associated with an autonomous vehicle;
compare the first sensor data with map data, wherein the map data that indicates a plurality of objects on a road, wherein the plurality of objects comprises a first object and a second object;
based at least in part upon the comparison between the first sensor data and the map data, determine that the first sensor data does not indicate a presence of the first object that is indicated in the map data;
in response to determining that the first sensor data does not indicate the presence of the first object that is indicated in the map data:
access second sensor data captured by a second sensor associated with the autonomous vehicle;
determine that the second sensor detects the first object based on determining that the second sensor data indicates the presence of the first object;
compare the first sensor data with the second sensor data;
based at least in part upon the comparison between the first sensor data and the second sensor data, determine that the first sensor fails to detect the first object; and
in response to determining that the first sensor fails to detect the first object, determine that the first sensor is associated with a first level of anomaly.

18. The non-transitory computer-readable medium of claim 17, wherein the instructions when executed by the processor, further cause the processor to:
determine that a plurality of sensors associated with the autonomous vehicle fail to detect the second object that is indicated in the map data;
in response to determining that the plurality of sensors associated with the autonomous vehicle fail to detect the second object that is indicated in the map data:
determine that the map data is out of data; and
update the map data by removing the second object from the map data.

19. The non-transitory computer-readable medium of claim 17, wherein:
comparing the first sensor data with the map data comprises:
extracting a first set of features from the first sensor data, the first set of features indicating objects detected by the first sensor data, wherein the first set of features is represented by a first feature vector that comprises a first set of numerical values;
extracting a second set of features from the map data, the second set of features indicating the plurality of objects, wherein the second set of features is represented by a second feature vector that comprises a second set of numerical values; and
comparing each of the first set of numerical values of the first feature vector with a counterpart numerical value from among the second set of numerical values,
wherein determining that the first sensor data does not indicate the presence of the first object that is indicated in the map data based at least in part upon the comparison between the first sensor data and the map data comprises:
determining that the first feature vector does not comprise numerical values that indicate the presence of the first object; and
determining that the second feature vector comprises the numerical values that indicate the presence of the first object at a particular location on the road.

20. The non-transitory computer-readable medium of claim 17, wherein:
comparing the first sensor data with the second sensor data comprises:
extracting a third set of features from the first sensor data, the third set of features indicating objects detected by the first sensor, wherein the third set of features is represented by a third feature vector that comprises a third set of numerical values;
extracting a fourth set of features from the second sensor data, the fourth set of features indicating objects detected by the second sensor, wherein the fourth set of features is represented by a fourth feature vector that comprises a fourth set of numerical values; and
comparing each of the third set of numerical values of the fourth feature vector with a counterpart numerical value from among the fourth set of numerical values,
determining that the first sensor fails to detect the first object that is detected by the second sensor based at least in part upon the comparison between the first sensor data and the second sensor data comprises:
determining that the third feature vector does not comprise numerical values that indicate the first object is detected on the road; and
determining that the fourth feature vector comprises the numerical values that indicate the presence of the first object at a particular location on the road.
